(19) United States
(12) Patent Application Publication
(10) Pub. No.: US 2019/0048242 A1
(43) Pub. Date: Feb. 14, 2019

(54) THERMAL STORAGE MEDIUM, AND THERMAL STORAGE PACK, THERMOSTATIC VESSEL, AND TRANSPORT BOX USING THE MEDIUM

(71) Applicant: SHARP KABUSHIKI KAISHA, Sakai City, Osaka (JP)

(72) Inventors: HWISIM HWANG, Sakai City (JP); DAIJI SAWADA, Sakai City (JP); YUKA UTSUMI, Sakai City (JP); HISANORI BESSHO, Sakai City (JP); SATORU MOTONAMI, Sakai City (JP); TETSUYA IDE, Sakai City (JP)

(21) Appl. No.: 16/075,576

(22) PCT Filed: Jan. 31, 2017
(86) PCT No.: PCT/JP2017/003351

§ 371 Date: Aug. 3, 2018

(30) Foreign Application Priority Data
Feb. 5, 2016 (JP) 2016-021131

(51) Int. Cl. C09K 5/06; F25D 11/00; F28D 20/02

(52) U.S. Cl. CPC C09K 5/063; F28D 20/02; F25D 11/006; C09K 5/066

(57) ABSTRACT

A flame-retardant thermal storage medium is provided that has an effective temperature range lower than the effective temperature range of congruent-melting-point-concentration TBAB without reducing the latent heat of the congruent-melting-point-concentration TBAB. The thermal storage medium changes phase at a prescribed temperature and contains: water; TBAB at such a concentration with respect to the water as to give a congruent melting point of a semi-clathrate hydrate; and KCl dissolved in the water. The thermal storage medium contains at least 0.90 moles of KCl per 1 mole of TBAB

### TECHNICAL FIELD

The present invention relates to thermal storage media that change phase at a prescribed temperature and also to thermal storage packs, thermostatic vessels, and transport boxes using such media.

### BACKGROUND ART

Commercial and other articles that need to be kept at a temperature for quality preservation have been conventionally kept at a range of temperature that is suitable for the articles during transport. For example, refrigerant cooled down to a required temperature is placed in a thermostatic box. The commercial article is then put into the thermostatic box so that the article can be kept at low temperature.

As another example, medicines and like articles need to be kept at 2° C. to 8° C. during transport. For this purpose, a thermal storage medium is needed that melts around 5° C. A current, commonly used thermal storage medium with a melting point of 5° C. is paraffin-based material, which is flammable. For this reason, studies are underway to develop a flame-retardant thermal storage medium that exhibits as much latent heat as paraffin, in order to replace paraffin-based material.

Clathrate hydrates, and semi-clathrate hydrates in particular, crystallize when an aqueous solution of their base compound is cooled below a temperature at which a hydrate is formed. The crystals will store thermal energy that may later be utilized as latent heat. The clathrate hydrate may therefore be used as a latent thermal storage medium or as a component of such a medium.

Substances worth a mention here are hydrates of quaternary ammonium salts, which are a typical example of semi-clathrate hydrates encaging a non-gaseous species as a guest compound. These hydrates form under normal pressure, give out a large amount of thermal energy (amount of stored heat) upon crystallization, and are unlike paraffin, inflammable. Therefore, hydrates of quaternary ammonium salts are easy to handle and therefore finding more and more applications than before in heat transport media and thermal storage tanks that are more efficient than ice thermal storage tanks used in buildings for air conditioning purposes.

Patent Literatures 1 and 2 have successfully lowered a congruent melting point by lowering the concentration of TBAB and also prepared a cold storage agent that has a desirable melting point by mixing a clathrate hydrate with a suitable amount of a substance whose melting point is lower than that of water as a melting point depressant.

### CITATION LIST

### Patent Literature

Patent Literature 1: Japanese Unexamined Patent Application Publication, Tokukai, No. 2005-126728

Patent Literature 2: Japanese Unexamined Patent Application Publication, Tokukaihei, No. 11-264681

### SUMMARY OF INVENTION

### Technical Problem

The cold storage agents disclosed in Patent Literatures 1 and 2 are, however, mixtures containing an aqueous solution that is in liquid phase at use temperatures to form a slurry of a clathrate hydrate. The mixed presence of an aqueous solution that is in liquid phase at use temperatures reduces latent heat, which will be explained next in reference to FIG. 14.

FIG. 14 gives a comparison of the latent heat of a conventional clathrate hydrate in an aqueous solution at different concentrations (maximum use temperature=12° C.). For example, the latent heat is 46 kcal/kg for 40 wt % TBAB (melting point is from 11.8 to 12° C.). As can be seen from FIG. 14, the latent heat decreases to 26 kcal/kg if the fill factor of the TBAB hydrate is changed to 56%. Meanwhile, when the fill factor of the TBAB hydrate for 27 wt % TBAB is changed to 43%, the latent heat stays at 26 kcal/kg, and the range of use temperatures broadens to 5 to 12° C. To put it differently, the minimum use temperature is lowered, but the latent heat is not maintained.

The present invention, having been made in view of these issues, has an object to provide a flame-retardant thermal storage medium that has an effective temperature range lower than the effective temperature range of congruent-melting-point-concentration TBAB without reducing the latent heat of the congruent-melting-point-concentration TBAB and also to provide a thermal storage pack, thermostatic vessel, and transport box using such a medium.

### Solution to Problem

To achieve this object, the present invention, in one aspect thereof, is directed to a thermal storage medium that changes phase at a prescribed temperature, the medium containing: water; TBAB at such a concentration with respect to the water as to give a congruent melting point of a semi-clathrate hydrate; and KCl dissolved in the water.

The thermal storage medium, thus containing water, TBAB, and KCl, can exhibit an effective temperature range lower than the effective temperature range of the congruent-melting-point-concentration TBAB while substantially maintaining the effective-temperature-range-sustaining time of the congruent-melting-point-concentration TBAB. In addition, the TBAB, used at such a concentration with respect to the water as to give a congruent melting point of a semi-clathrate hydrate, can preserve the amount of latent heat for a lower effective temperature range.

### Advantageous Effects of Invention

The present invention can provide a thermal storage medium that has an effective temperature range lower than the effective temperature range of congruent-melting-point-concentration TBAB while substantially maintaining the effective-temperature-range-sustaining time of the congruent-melting-point-concentration TBAB.

### BRIEF DESCRIPTION OF DRAWINGS

FIG. 1 is a graphical representation of results of measurement of temperature changes in Comparative Example and Example 1.

FIG. 2 is a graphical representation of results obtained by DSC in Example 1 and Comparative Example.

FIG. 3 is a graphical representation of results obtained by DSC in Example 1 and Example 2.

FIG. 4 is a graphical representation of results obtained by DSC in Example 1 and Example 3.

FIG. 5 is a graphical representation of results obtained by DSC in Example 1 and Example 4.

FIG. 6 is a graphical representation of results obtained by DSC in Example 1 and Example 5.

FIG. 7 is a graphical representation of results obtained by DSC in Example 1 and Example 6.

FIG. 8 is a graphical representation of results obtained by DSC in Example 1 and Example 7.

FIG. 9 is a graphical representation of results obtained by DSC in Example 1 and Example 7a.

FIG. 10 is a graphical representation of results obtained by DSC in Example 1 and Example 8.

FIG. 11 is a graphical representation of temperature changes during the freezing of a thermal storage medium in accordance with Example 1.

FIG. 12 is a cross-sectional view of a thermostatic vessel in accordance with a second embodiment.

FIG. 13 is a perspective view of a transport box in accordance with a third embodiment.

FIG. 14 shows a comparison of the latent heat of a conventional clathrate hydrate in an aqueous solution at different concentrations.

### DESCRIPTION OF EMBODIMENTS

A description will be now given of embodiments of the present invention in reference to drawings.

### First Embodiment

### Composition of Thermal Storage Medium

A thermal storage medium in accordance with the present invention is a latent thermal storage medium that changes phase at a prescribed temperature and is composed primarily of water, tetra-n-butylammonium bromide (hereinafter, “TBAB”), and potassium chloride (hereinafter, “KCl”).

TBAB is a quaternary ammonium salt. The quaternary ammonium salt hydrate is a typical example of a semi-clathrate hydrate encaging a non-gaseous species as a guest compound, forms under normal pressure, and gives out a large amount of thermal energy (amount of stored heat) upon crystallization. Unlike paraffin, the quaternary ammonium salt hydrate is inflammable and hence easy to handle. By using TBAB which forms semi-clathrate hydrates of this nature, a large amount of latent heat energy becomes available for applications.

The present embodiment uses TBAB which forms such semi-clathrate hydrates. The TBAB semi-clathrate hydrate preferably has a concentration of 40.5 wt %±0.5 w %/o with respect to water. The molar ratio of KCl to TBAB is preferably more than or equal to 0.90.

Mixing KCl, which has a higher melting point than water, with water and TBAB of such a concentration with respect to the water as to give a congruent melting point of a semi-clathrate hydrate can suppress formation of slurry of a clathrate hydrate and provide an effective temperature range lower than the effective temperature range of the congruent-melting-point-concentration TBAB while substantially maintaining the effective-temperature-range-sustaining time of the congruent-melting-point-concentration TBAB, that is, preserving the amount of latent heat produced at melting point by the congruent-melting-point-concentration TBAB.

This composition can lower the onset temperature of melting of TBAB from 12° C. to about 4° C. and can also lower the maximum temperature to 8° C. or even further. The onset temperature of melting may be lowered by lowering the TBAB concentration. By doing so, however, the durability of the thermal storage medium is also lowered. In contrast, the thermal storage medium in accordance with the present embodiment contains a TBAB semi-clathrate hydrate at a concentration of 40.5 wt %±0.5 wt % with respect to water and substantially maintains the congruent melting point concentration. Therefore, the thermal storage medium in accordance with the present embodiment is less likely to lose its durability.

Method of Preparing Thermal Storage Medium

First, TBAB (40.0 grams (=0.124 mol) to 41.0 grams (=0.127 mol)), water (59.0 grams to 60.0 grams), and KCl (8.33 grams (=0.112 mol) to 9.48 grams (=0.127 mol)) are prepared which are ingredients of the thermal storage medium in accordance with an aspect of the present invention. Among these ingredients prepared, the water and TBAB are first mixed at room temperature. The KCl is then added and mixed with a resultant liquid mixture, which completes the preparation of the thermal storage medium. The order of adding and mixing the ingredients may be changed: the water and KCl may be mixed before the TBAB is added and mixed with a resultant water-KCl liquid mixture.

### Measurement Experimentation

Next will be described measurement experimentation performed on thermal storage media. In the measurement experimentation, thermal storage media were prepared from different amounts of ingredients and subjected to (1) measurement of temperature changes, (2) differential scanning calorimetry (DSC), and (3) measurement of freezing point.

Table 1 shows the TBAB, water, and KCl contents of each thermal storage medium used in measurement (1) to (3).

TABLE 1

| | | | | Molar Ratio |
|---|---|---|---|---|
| | TBAB | Water | KCl | (TBAB:KCl) |
| Comparative | 40.5 g(0.126 | 59.5 g(3.306 | — | — |
| Example | mol) | mol) | | |
| Examples 1, | 40.5 g(0.126 | 59.5 g(3.306 | 9.37 g(0.126 | 1:1 |
| 7, and 7a | mol) | mol) | mol) | |
| Example 2 | 40.5 g(0.126 | 59.5 g(3.306 | 8.43 g(0.113 | 1:0.90 |
| | mol) | mol) | mol) | |
| Example 3 | 40.0 g(0.124 | 60.0 g(3.333 | 9.25 g(0.124 | 1:1 |
| | mol) | mol) | mol) | |
| Example 4 | 40.0 g(0.124 | 60.0 g(3.333 | 8.33 g(0.112 | 1:0.90 |
| | mol) | mol) | mol) | |
| Example 5 | 41.0 g(0.127 | 59.0 g(3.278 | 9.48 g(0.127 | 1:1 |
| | mol) | mol) | mol) | |
| Example 6 | 41.0 g(0.127 | 59.0 g(3.278 | 8.53 g(0.114 | 1:0.90 |
| | mol) | mol) | mol) | |
| Example 8 | 35.0 g(0.109 | 65.0 g(3.611 | 10.0 g(0.134 | 1:1.2 |
| | mol) | mol) | mol) | |

The thermal storage medium in accordance with Comparative Example was prepared by mixing TBAB and water in such a conventional manner as to contain TBAB at the congruent melting point concentration (40.5 wt %). The thermal storage media in accordance with Examples 1 to 6 and 8 were prepared by mixing water and TBAB before adding and mixing KCl with a resultant water-TBAB liquid mixture. The thermal storage medium in accordance with Example 7 was prepared by mixing water and KCl before adding and mixing TBAB with a resultant water-KCl liquid mixture.

### 1. Measurement of Temperature Changes

Temperature changes were measured of the thermal storage media in accordance with Comparative Example and Example 1.

### Measurement Procedures

Samples (50 grams each) of these prepared thermal storage media were put into respective plastic containers and frozen at −30° C. in a thermostatic chamber. After that, the environmental temperature was changed to 30° C., and changes in temperature of the thermal storage media were measured. Results are presented below. Note that the internal temperature of the thermostatic chamber was increased from −30° C. to 30° C. at a rate of 1° C./min and thereafter maintained at 30° C.

### Results of Measurement

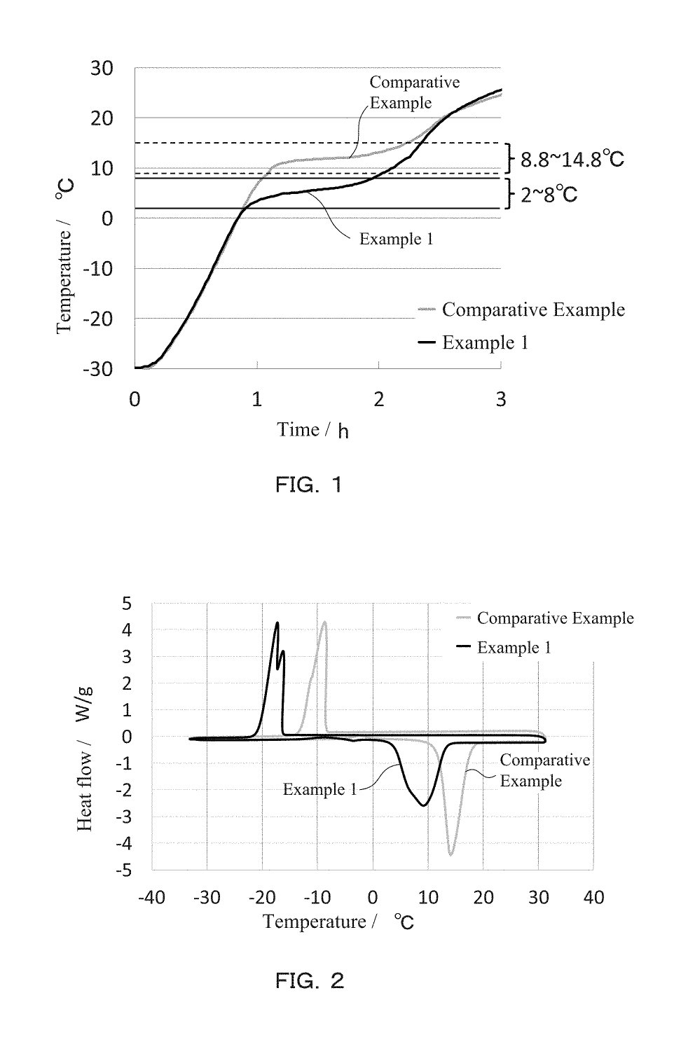

FIG. 1 is a graphical representation of results of measurement of temperature changes in Comparative Example and Example 1. Solid lines indicate the effective temperature range, 2° C. to 8° C., of a thermal storage medium 1. Broken lines indicate the effective temperature range, 8.8° C. to 14.8° C., of Comparative Example. The effective temperature range of Comparative Example was set to 11.8° C. (=melting point)±3° C. (the temperature width was set to 6° C., which is the same value for the thermal storage medium 1) because the thermal storage medium in accordance with Comparative Example has a melting point of 11.8° C. The duration of time in which temperature could be maintained within the effective temperature range was 63 minutes in Example 1 and 67 minutes in Comparative Example.

It is understood from these results that by adding KCl to a 40.5 wt % (=congruent melting point concentration) aqueous solution of TBAB in a molar ratio KCl:TBAB=1:1, the resultant thermal storage medium exhibits an effective temperature range lower than the effective temperature range of the congruent-melting-point-concentration TBAB while substantially maintaining the effective-temperature-range-sustaining time of the congruent-melting-point-concentration TBAB.

Specific heat is generally larger in liquid phase than in solid phase. For this reason, if Example 1 contained liquid phase, specific heat would be larger in Example 1 than in Comparative Example. Example 1 and Comparative Example would not exhibit the same temperature changes; temperature would increase more slowly in Example 1 than in Comparative Example. FIG. 1 shows, however, that temperature changes in the same manner in Comparative Example and Example 1 at and below 2° C. Therefore, it is concluded that Comparative Example and Example 1 are solids that do not exhibit melting behavior at other temperatures (i.e., Comparative Example and Example 1 have a single melting point), in other words, solids with no liquid phase.

### 2. Differential Scanning Calorimetry (DSC)

Differential scanning calorimetry (DSC) was performed on the thermal storage media in accordance with Comparative Example and Examples 1 to 8.

### Temperature Conditions

Temperature conditions during differential scanning calorimetry were as follows. Temperature was decreased from 30° C. to −30° C. at 5° C./min, maintained at −30° C. for 5 minutes, and then increased from −30° C. to 30° C. at 5° C./min.

### Results of Measurement

FIGS. 2 to 10 are graphical representations of results obtained by differential scanning calorimetry in Example 1, Comparative Example, and Examples 2 to 8. Table 2 shows the extrapolated onset temperature of melting (melting point) (° C.) and latent heat (J/g) of each thermal storage medium.

TABLE 2

| | Extrapolated Onset | |
|---|---|---|
| | Temperature of Melting[° C.] | Latent Heat[J/g] |
| Comparative | 12.0 | 176.0 |
| Example | | |
| Example 1 | 4.0 | 172.1 |
| Example 2 | 3.7 | 173.3 |
| Example 3 | 4.0 | 172.2 |
| Example 4 | 4.0 | 166.6 |
| Example 5 | 4.0 | 174.4 |
| Example 6 | 3.9 | 174.0 |
| Example 7 | 4.0 | 169.2 |
| and 7a | −14.8 | 8.7 |
| Example 8 | 5.0 | 138.8 |
| | −13.7 | 44.3 |

Extrapolated onset temperature of melting (melting point) is determined by extrapolating the temperature at which an endothermic peak starts toward a baseline on a DSC thermogram obtained by DSC. Latent heat is calculated from an area of an endothermic peak on a DSC thermogram obtained by DSC.

The following will discuss the extrapolated onset temperatures of melting (melting points) and latent heats of the thermal storage media in accordance with Comparative Example and Examples 1 to 8 in comparison with those of the thermal storage medium in accordance with Example 1.

### Example 1 as Compared with Comparative Example

FIG. 2 is a graphical representation of results obtained by DSC in Comparative Example and Example 1. FIG. 2 shows that the extrapolated onset temperature of melting was decreased from 12° C. to 4° C. by mixing KCl with a 40.5 wt % aqueous solution of TBAB in a molar ratio KCl:TBAB=1:1, without much reducing latent heat.

### Example 1 as Compared with Example 2

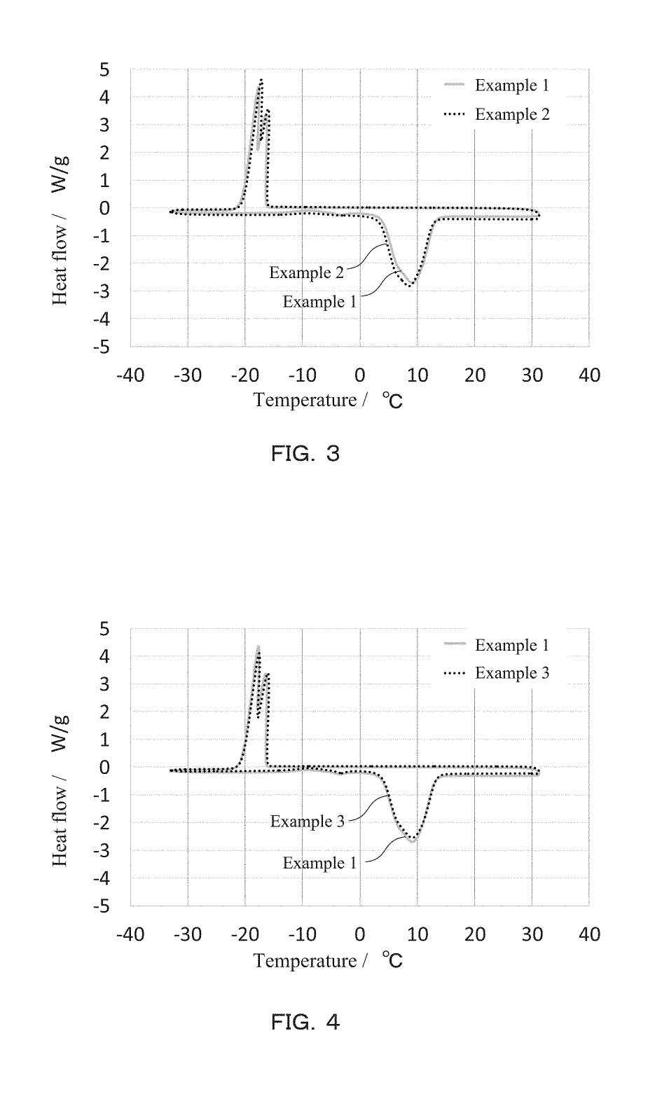

FIG. 3 is a graphical representation of results obtained by DSC in Example 1 and Example 2. FIG. 3 shows that the extrapolated onset temperature of melting and latent heat changed no more than −0.3° C. and +0.7% respectively when the molar ratio KCl:TBAB was changed from 1:1 to 0.90:1.

### Example 1 as Compared with Example 3

FIG. 4 is a graphical representation of results obtained by DSC in Example 1 and Example 3. FIG. 4 shows that the DSC thermogram hardly changed, the extrapolated onset temperature of melting remained the same, and the latent heat remained almost the same in a thermal storage medium obtained by mixing KCl with a 40.0 wt % aqueous solution of TBAB (the TBAB content was changed to 40.0 grams) in a molar ratio KCl:TBAB=1:1.

### Example 1 as Compared with Example 4

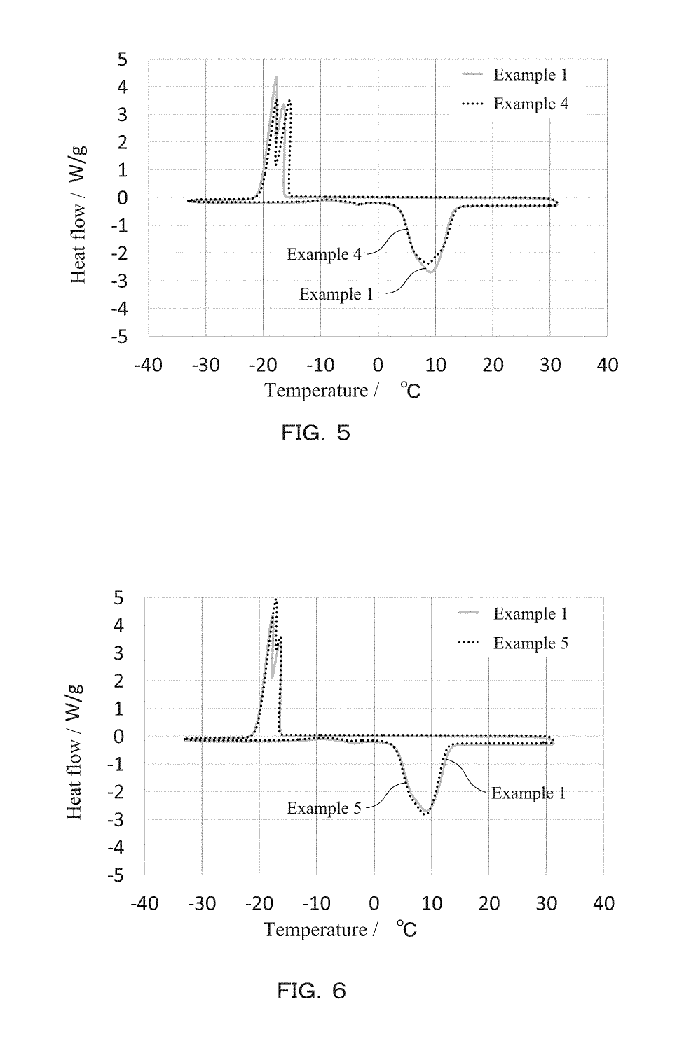

FIG. 5 is a graphical representation of results obtained by DSC in Example 1 and Example 4. FIG. 5 shows that the extrapolated onset temperature of melting remained the same, and the latent heat changed no more than −3.2%, when the TBAB content was changed from 40.5 grams to 40.0 grams (to obtain a 40.0 wt/aqueous solution of TBAB to which KCl would be added) and the molar ratio KCl:TBAB was changed from 1:1 to 0.90:1.

### Example 1 as Compared with Example 5

FIG. 6 is a graphical representation of results obtained by DSC in Example 1 and Example 5. FIG. 6 shows that the extrapolated onset temperature of melting remained the same, and the latent heat changed no more than +1.3% in a thermal storage medium obtained by mixing KCl with a 41.0 wt % aqueous solution of TBAB (the TBAB content was changed to 41.0 grams) in a molar ratio KCl:TBAB=1:1.

### Example 1 as Compared with Example 6

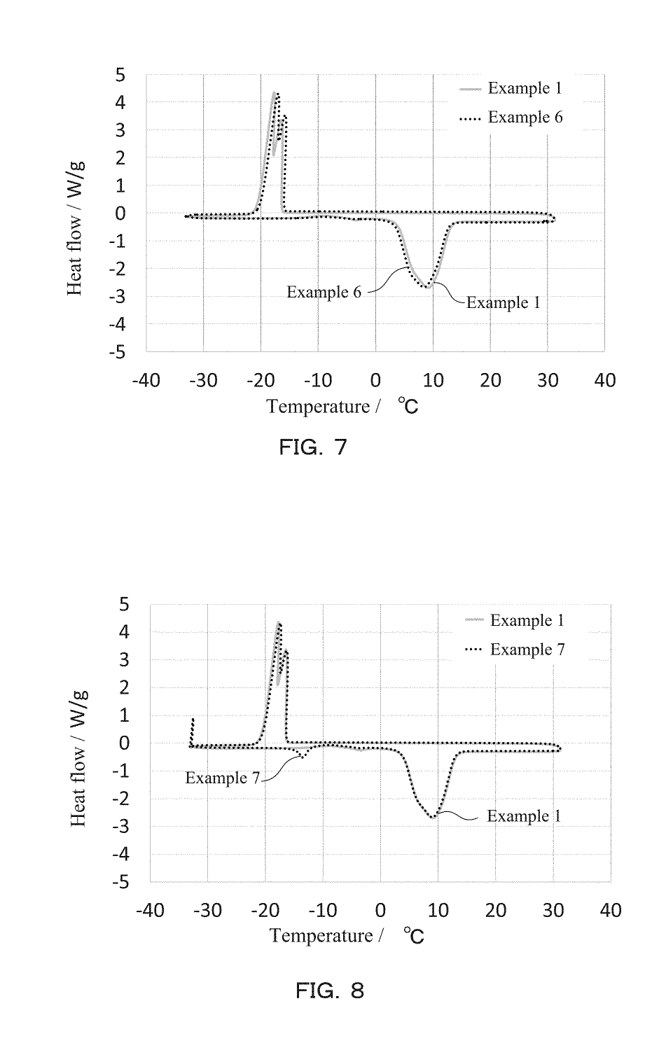

FIG. 7 is a graphical representation of results obtained by DSC in Example 1 and Example 6. FIG. 7 shows that the extrapolated onset temperature of melting and latent heat changed no more than −0.1° C. and +1.1% respectively when the TBAB content was changed from 40.5 grams to 41.0 grams (to obtain a 41.0 wt % aqueous solution of TBAB to which KCl would be added) and the molar ratio KCl:TBAB was changed from 1:1 to 0.90:1.

### Example 1 as Compared with Example 7

FIG. 8 is a graphical representation of results obtained by DSC in Example 1 and Example 7. There appeared only one extrapolated onset temperature of melting at 4.0° C. in Example 1. In contrast, in Example 7, there appeared two extrapolated onset temperatures of melting at 4.0° C. and −14.8° C. By reversing the order of adding and mixing TBAB and KCl, there appeared two extrapolated onset temperatures of melting. The latent heat, however, changed no more than −1.7% at one of the two extrapolated onset temperatures of melting 4.0° C. and was as low as 8.7 J/g at the other extrapolated onset temperature of melting −14.8° C. It is concluded that the DSC thermogram hardly changed in Example 7 when compared with Example 1.

Meanwhile, in Example 7, there appeared an exothermic peak, which was missing in Comparative Example and Examples 1 to 6, at or below −30° C. (=minimum temperature). The exothermic peak appeared due to solidification of a substance that melted at −14.8° C. The addition of KCl before TBAB presumably made the aqueous solution of KCl easier to freeze. To verify this presumption, the same measurement was performed as Example 7a with a change in minimum temperature from −30° C. to −40° C.

### Temperature Conditions in Example 7a

The temperature of a thermal storage medium in accordance with Example 7 was decreased from 30° C. to −40° C. at 5° C./min, maintained at −40° C. for 5 minutes, and then increased from −40° C. to 30° C. at 5° C./min. In other words, the minimum temperature was changed from −30° C. to −40° C.

### Results of Measurement in Example 7a

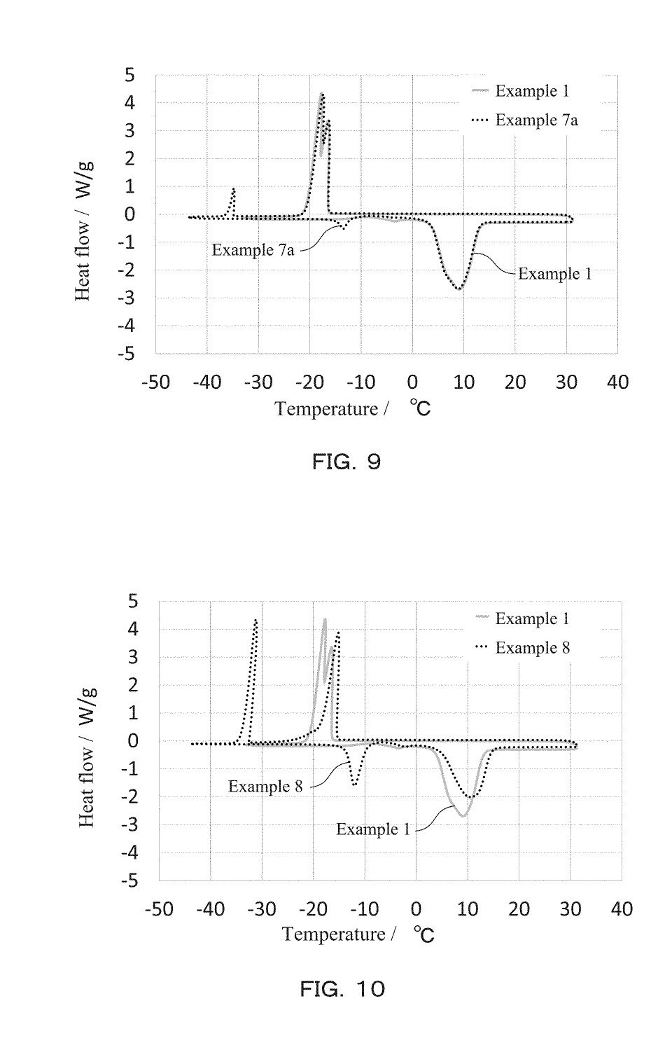

FIG. 9 is a graphical representation of results obtained by DSC in Example 1 and Example 7a. FIG. 9 shows that there appeared an exothermic peak at or below −30° C. in Example 7a as in Example 7. FIG. 9 also shows that the extrapolated onset temperature of melting and latent heat in Example 7a were not different from those in Example 7. As described above, the latent heat produced at −14.8° C. was as low as 8.7 J/g. This latent heat at the lower melting point does not seem to cause the latent heat at the higher melting point to drop. It is hence concluded that the thermal storage medium had substantially the same effects regardless of whether KCl or TBAB was added first.

### Example 1 as Compared with Example 8

Heat flow was measured in Example 8 with the minimum temperature being changed to −40° C. as in Example 7a. FIG. 10 is a graphical representation of results obtained by DSC in Example 1 and Example 8. There appeared only one extrapolated onset temperature of melting at 4.0° C. in Example 1. In contrast, in Example 8, there appeared two extrapolated onset temperatures of melting at 5.0° C. and −13.7° C. By reducing the TBAB concentration to 35.0 wt %, there appeared an extrapolated onset temperature of melting at −13.7° C. The reduced TBAB concentration produced, in the aqueous solution, excess water that became a KCl aqueous solution, which in turn further increased the melting latent heat over Example 7 and Example 7a. It was then observed that the increased melting latent heat reduced latent heat at 5.0° C. (=extrapolated onset temperature of melting). Therefore, the TBAB concentration is preferably not lowered and should be 40.0 wt % or higher at which there occurs a stable heat flow as in preceding examples.

These comparisons indicate that the thermal storage medium in accordance with Example 1, prepared by mixing KCl with a 40.5 wt % aqueous solution of TBAB in a molar ratio KCl:TBAB=1:1, is the most preferred. The comparisons also indicate that a thermal storage medium is obtainable that changes phase at 2° C. to 8° C. if the TBAB has a weight percentage of 40.5 wt %±0.5 with respect to the water and the KCl has a molar ratio of at least 0.90 with respect to the TBAB.

In addition, KCl is preferably added to the aqueous solution of TBAB in such an amount as not to exceed its saturation level. For example, when KCl was added to a 40.5 wt % aqueous solution of TBAB adjusted to 20° C. in a molar ratio KCl:TBAB=1.39:1 (i.e., 13 grams of KCl was added to 100 grams of a 40.5 wt % aqueous solution of TBAB), it was observed that the KCl dissolved completely. Meanwhile, when KCl was added to the same aqueous solution (40.5 wt % aqueous solution of TBAB adjusted to 20° C.) in a molar ratio KCl:TBAB=1.49:1 (i.e., 14 grams of KCl was added to 100 grams of a 40.5 wt % aqueous solution of TBAB), the KCL did not dissolve completely and produced some precipitate.

From these observations, it is concluded that under these conditions, KCl is preferably added in a molar ratio KCl:TBAB≤1.39:1. If more than this amount of KCl is mixed, the resultant thermal storage medium (or refrigerant) exhibits a decrease in effective latent heat per unit weight that corresponds to the mass of the KCl that precipitates without being dissolved.

### 3. Measurement of Freezing Point

The freezing point was measured of the thermal storage medium in accordance with Example 1.

### Measurement Procedures

A sample (50 grams) of the thermal storage medium in accordance with Example 1 were put into respective plastic containers, which were in turn placed in a 30° C. thermostatic chamber. The internal temperature of the thermostatic chamber was decreased from 30° C. to −30° C. at 1° C./min and thereafter maintained at −30° C.

### Results of Measurement

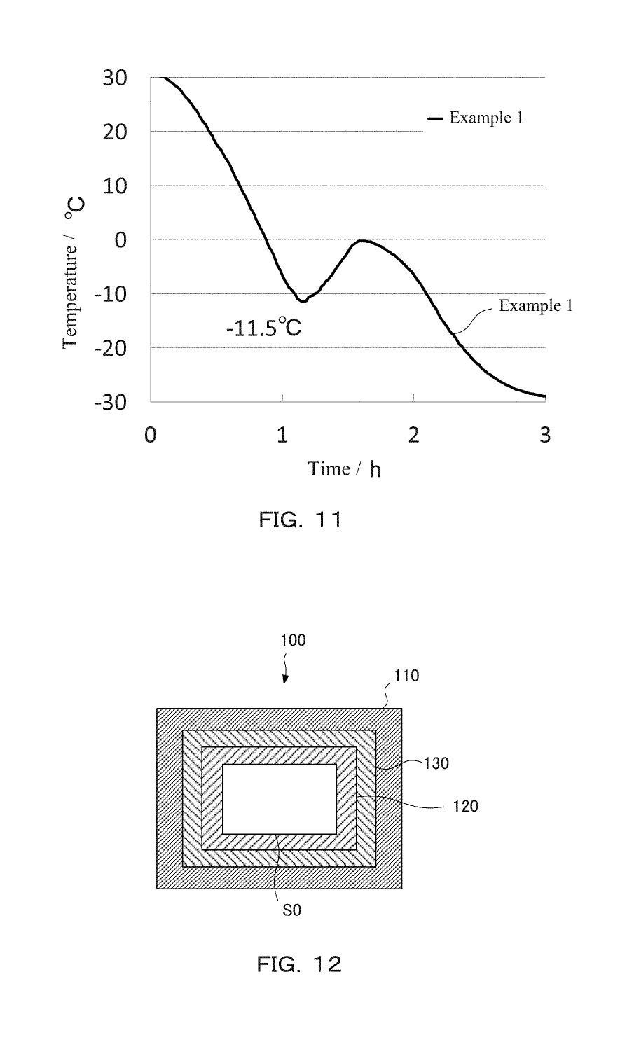

FIG. 11 is a graphical representation of temperature changes during the freezing of a thermal storage medium in accordance with Example 1. FIG. 11 shows that the thermal storage medium of Example 1 started freezing at −11.5° C., which indicates that the thermal storage medium of Example 1 can freeze at a common home freezer temperature (−18° C.). It is safely presumed that similar conclusions will be derived from Examples 2 to 8, in which practically the same ingredients are used in practically the same amounts.

### Second Embodiment

The thermal storage media are applicable to thermostatic vessels. FIG. 12 is a cross-sectional view of a thermostatic vessel in accordance with the present embodiment. A thermostatic vessel 100 includes a thermostatic vessel main body 110 and a thermal storage pack 120. The thermal storage pack 120 includes a thermal storage medium and a packaging material that covers the thermal storage medium. The thermal storage pack 120 is placed in a position where the thermal storage pack 120 can exchange heat with an article S0 that needs to be kept cold. The packaging material that covers the thermal storage medium may be either a soft container composed of a film or other soft substance or a hard container composed of plastic (e.g., PE or PP) or like hard substance. The thermal storage pack 120 may be fabricated into a size or shape that is suited to the usage of the thermal storage medium.

The thermostatic vessel main body 110 houses the article S0 and the thermal storage pack 120 so that the thermal storage pack 120 can keep the precooled article S0 at low temperature. This structure enables the thermostatic vessel main body 110 to house the article S0 while maintaining the inside of the thermostatic vessel at 2° C. to 8° C. The structure further enables articles such as vaccines and like medicines that need to be kept at 2° 2 to 8° C. to be stored at a suitable temperature for a period of time, without damaging their effects.

A thermal insulation material 130 may also be included in the thermostatic vessel 100 either between the thermal storage pack 120 and the article S0 that needs to be kept cold or outside the thermal storage pack 120. The thermal insulation material 130, thus housed inside the thermostatic vessel 100, restrains the article S0 from being warmed up by heat dissipated by the thermal storage medium. That in turn enables the article S0 to be kept at a suitable temperature for an extended period of time.

### Third Embodiment

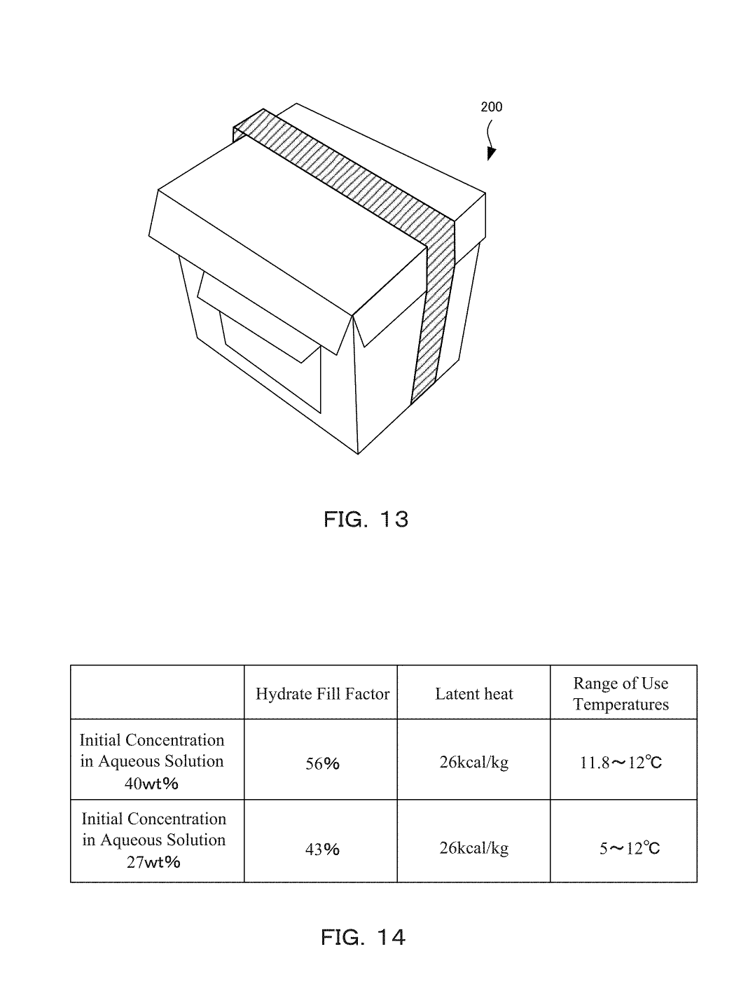

The thermal storage media are applicable to transport boxes. FIG. 13 is a perspective view of a transport box in accordance with the present embodiment. A transport box 200 can house the thermostatic vessel 100. The transport box may be as small as a hand carry bag or as large as a shipping container. The thermostatic vessel 100, thus housed inside the transport box 200, enables the article S0 to be transported while being maintained at a suitable temperature.

The transport box 200 may be composed of a thermally insulating substance. The thermostatic vessel 100, housed inside the transport box 200 composed of a thermally insulating substance, restrains the internal temperature of the transport box 200 from changing due to thermal conduction. That in turn enables the article S0 to be kept at a suitable temperature for a further extended period of time.

The transport box 200 may be composed of a sheet that blocks radiant heat. The thermostatic vessel 100, housed inside the transport box 200 composed of a radiant-heat-blocking sheet, restrains the internal temperature of the transport box 200 from changing due to radiant heat. That in turn enables the article S0 to be kept at a suitable temperature for a further extended period of time.

This international application claims priority to Japanese Patent Application No. 2016-021131 filed on Feb. 5, 2016, the entire contents of which are incorporated herein by reference.

### REFERENCE SIGNS LIST

S0 Article
100 Thermostatic Vessel
110 Thermostatic Vessel Main Body
120 Thermal Storage Pack
130 Thermal Insulation Material
200 Transport Box

1. A thermal storage medium that changes phase at a prescribed temperature, the medium comprising:
water;
TBAB at such a concentration with respect to the water as to give a congruent melting point of a semi-clathrate hydrate; and
KCl dissolved in the water.

2. The thermal storage medium according to claim 1, containing at least 0.90 moles of KCl per 1 mole of TBAB.

3. The thermal storage medium according to claim 1, melting at 2° C. to 8° C.

4. The thermal storage medium according to claim 1, freezing at or above −18° C.

5. A thermal storage pack comprising:
the thermal storage medium according to claim 1; and
a packaging material that covers the thermal storage medium.

6. A thermostatic vessel that maintains a temperature of an article, the vessel comprising:
the thermal storage pack according to claim 5 placed in a position where the thermal storage pack can exchange heat with the article; and
a vessel main body that houses the article and the thermal storage pack.

7. The thermostatic vessel according to claim 6, further comprising a thermal insulation material disposed either between the article and the thermal storage pack or outside the thermal storage pack.

8. (canceled)

9. The thermal storage medium according to claim 2, melting at 2° C. to 8° C.

10. The thermal storage medium according to claim 2, freezing at or above −18° C.

11. The thermal storage medium according to claim 3, freezing at or above −18° C.

12. The thermal storage medium according to claim 9, freezing at or above −18° C.
